(19) United States
(12) Patent Application Publication
(10) Pub. No.: US 2014/0297058 A1
(43) Pub. Date: Oct. 2, 2014

(54) System and Method for Capturing and Preserving Vehicle Event Data

(71) Applicant: HAND HELD PRODUCTS, INC., Fort Mill, SC (US)

(72) Inventors: Lisa Barker, Roswell, GA (US); Leonard Knight, Snellville, GA (US); James Chamberlin, Tucker, GA (US)

(73) Assignee: Hand Held Products, Inc., Fort Mill, SC (US)

(21) Appl. No.: 13/852,097

(22) Filed: Mar. 28, 2013

(51) Int. Cl. G07C 5/00

(52) U.S. Cl. CPC G07C 5/008
USPC 701/1

(57) ABSTRACT

The invention relates to a system and method for capturing and preserving vehicle event data. A vehicle-mount computer is adapted to capture video and other data relating to the operation of the vehicle. Event sensors inform the system of the occurrence of a vehicle event, which may include a sudden deceleration or change in yaw indicative of a vehicle accident. Upon the occurrence of a vehicle event, the system preserves the data for later use in the investigation of the vehicle event.

### FIELD OF THE INVENTION

The present invention relates generally to computer systems, and, more specifically, to a system and method for capturing and preserving vehicle event data using a vehicle-mount computer.

### BACKGROUND OF THE INVENTION

Businesses have achieved greater productivity in recent years by deploying mobile computing devices into the field to assist workers. For example, workers use vehicle-mount computers to help compile important data in the field. Vehicle-mount computers are computing devices that are specially designed to mount to a vehicle and be used by the vehicle operator. For instance, several types of vehicle-mount computers are available for installation in forklifts, cranes and other industrial vehicles and commercial vehicles. A forklift operator can, for example, view and record inventory data directly from the cabin of the forklift through a vehicle-mount computer. The vehicle-mount computer may display the exact location in the warehouse where the forklift operator can find the next item to be loaded onto a shipping container. In addition, the forklift operator can use the vehicle-mount computer to enter information in real-time regarding shipped or inventoried products. Whereas inventory tracking once required time-intensive and error-prone centralized data processing techniques, vehicle-mount computers deployed in the field now allow for real-time inventory tracking using a distributed network of computers.

Although businesses have effectively employed vehicle-mount computers to increase worker productivity and improve the tracking of goods along the supply chain, the safety of workers in the field and the protection of the business' transportation assets continue to be areas of concern for businesses. Forklift operators, for example, can encounter accidents as they navigate their vehicles through large, busy warehouses and loading docks where they load and unload heavy, sometimes unstable, cargo. When an accident involving a forklift occurs, it is sometimes difficult for the business to obtain accurate information regarding the precise circumstances leading up to the accident. A lack of reliable information regarding the cause of an accident can impede efforts to implement procedures or other measures to prevent similar incidents from occurring in the future. In addition, to the extent that there may be legal implications resulting from an accident involving a forklift, a lack of reliable information regarding the accident could unnecessarily expose the business to legal liability, including third-party liability.

What is needed is a way to harness the computing capabilities of a vehicle-mount computer in a novel way that allows for the collection of data regarding an incident involving the industrial vehicle (e.g., vehicle event data) which houses the vehicle-mount computer. In particular, there exists a need for a system that augments existing vehicle-mount computer designs to allow these vehicle-mount computers to obtain and store video data relating to a vehicle event.

### SUMMARY OF THE INVENTION

In one aspect, the present invention embraces a system for capturing and preserving vehicle event data.

In another aspect, the present invention embraces a method of capturing and preserving vehicle event data.

In another aspect, the present invention embraces a vehicle adapted to capture and preserve vehicle event data.

The foregoing, as well as other objectives and advantages of the invention, and the manner in which the same are accomplished, are further specified within the following detailed description and its accompanying drawings.

### BRIEF DESCRIPTION OF THE DRAWINGS

FIG. 1 is a schematic block diagram illustrating the components of an exemplary system according to the present invention.

FIG. 2 is a flow chart depicting the logical operation of an exemplary video manager of an exemplary system according to the present invention.

FIG. 3 is a perspective view of an exemplary vehicle adapted to capture and preserve vehicle event data according to the present invention.

### DETAILED DESCRIPTION

The present invention embraces a system and method for capturing and preserving vehicle event data. In particular, the present invention embraces a system and method for capturing and preserving vehicle event data using a vehicle-mount computer.

In an exemplary embodiment, the system for capturing and preserving vehicle event data according to the present invention includes a vehicle-mount computer having a central processing unit, a main memory, a system bus, a mass storage device, an operating system stored on the mass storage device and executed by the central processing unit, an input device for receiving input from a user, a display device, and a video manager adapted to preserve a designated duration of pre-event video and a designated duration of post-event video. Typically, the components of the vehicle-mount computer are operably connected to each other by the system bus. The exemplary system also includes an event sensor operably connected to the vehicle-mount computer, as well as an imaging device operably connected to the vehicle-mount computer.

In an exemplary embodiment, the method for capturing and preserving vehicle event data according to the present invention includes the step of providing a vehicle-mount computer having a central processing unit, a system bus, a main memory, a mass storage device, an operating system stored on the mass storage device and executed by the central processing unit, an input device for receiving input from a user, a display device, a network adapter, and a video manager adapted to preserve a designated duration of pre-event video and a designated duration of post-event video. The exemplary method according to the present invention further includes the steps of connecting an event sensor to the vehicle-mount computer, connecting an imaging device to the vehicle-mount computer, and, upon detection of a vehicle event by an event sensor, preserving a designated duration of pre-event video and a designated duration of post-event video.

In an exemplary embodiment, the vehicle adapted to capture and preserve vehicle event data according to the present invention includes a vehicle, a vehicle-mount computer having a central processing unit, a system bus, a main memory, a mass storage device, an operating system stored on the mass storage device and executed by the central processing unit, an input device for receiving input from a user, a display device, and a video manager adapted to preserve a designated duration of pre-event video and a designated duration of post-event video. The vehicle-mount computer is mounted to the vehicle. The exemplary vehicle according to the present invention further includes an event sensor operably connected to the vehicle-mount computer and an imaging device operably connected to the vehicle-mount computer.

Typical vehicles employing the system for capturing and preserving vehicle event data according to the present invention include forklifts, cranes and similar industrial vehicles (e.g., vehicles used primarily in an industrial, factory or warehouse setting). References in the disclosure and in the drawings to particular types of vehicles are not intended to limit the disclosure in any way to particular vehicles.

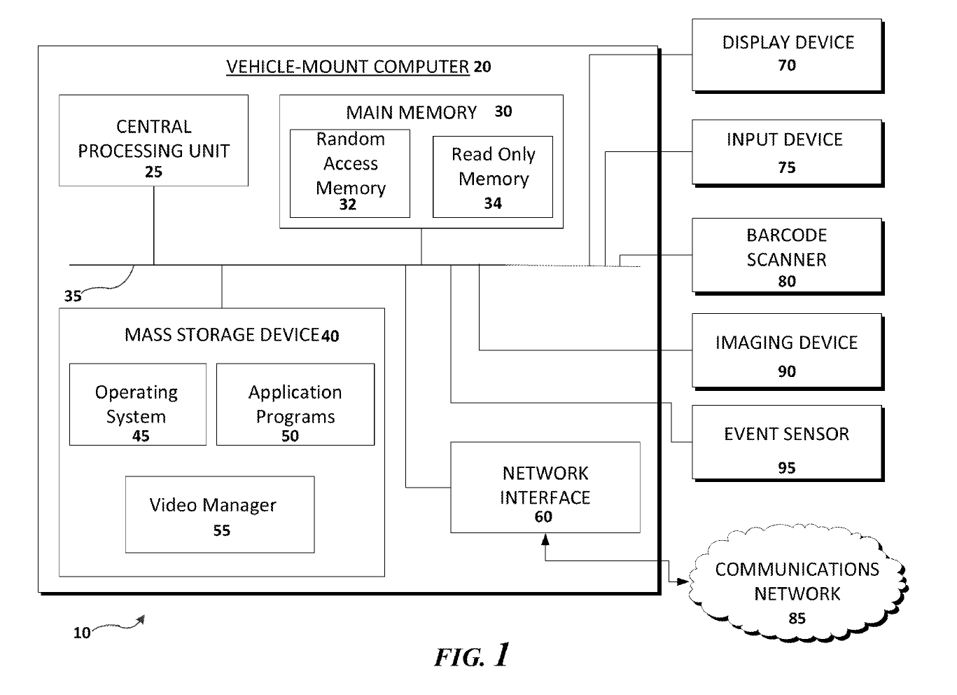

Referring now to the drawings, FIG. 1 is a schematic block diagram illustrating the components of an exemplary system 10 according to the present invention. A vehicle-mount computer 20 includes a mass storage device 40 for storing an operating system 45 and application programs 50. The mass storage device 40 may store other types of information. The operating system 45 is software that controls the overall operation of the vehicle-mount computer 20, including process scheduling and management, process protection, and memory management. Examples of a suitable operating system include, without limitation, WINDOWS® 7 and WINDOWS® EMBEDDED COMPACT (i.e., WINDOWS® CE) from MICROSOFT® CORPORATION of Redmond, Wash., and the LINUX® open source operating system. Typically, the operating system 45 is loaded by booting the vehicle-mount computer 20 and is executed directly by the central processing unit 25. An application program 50 is an executable software program designed to help the vehicle operator perform specific tasks. The application programs 50 may load automatically upon execution of the operating system 45 or in response to a command input from the vehicle operator. A main memory 30 provides for storage of instructions and data directly accessible by the central processing unit 25. Main memory 30 may include random-access memory 32 (RAM) and read-only memory 34 (ROM). The ROM 34 may permanently store firmware or a basic input/output system (BIOS), which provide the first instructions to the vehicle-mount computer 20 when it boots up. The RAM 32 typically serves as temporary and immediately accessible storage for the operating system 45 and application programs 50. The mass storage device 40 may be any of the various types of computer components capable of storing large amounts of data in a persisting (i.e., non-volatile) and machine-readable manner. Typically, the mass storage device 40 will be a hard disk drive. Alternatively, the mass storage device 40 may be a solid state drive, optical drive, removable flash drive or other component with similar storage capabilities.

A display device 70 is operably connected to the vehicle-mount computer 20. The display device 70 displays information to the user in the form of text or graphical output generated by the vehicle-mount computer 20. Typically, the display device 70 is a liquid crystal display (LCD) video monitor. An input device 75 is operably connected to the vehicle-mount computer. The input device 75 facilitates the input of instructions by the user. Typically, the input device 75 is a keyboard and/or a mouse. A barcode scanner 80 is operably attached to the vehicle-mount computer 20. The barcode scanner 80 serves as an alternate method of receiving user input, and provides for quick, reliable (e.g., not susceptible to typographical errors) data entry.

An exemplary embodiment of the vehicle-mount computer 20 of the system 10 according to the present invention also includes a network interface 60. The network interface 60 is logically connected to a communications network 65, thereby enabling the vehicle-mount computer 20 to communicate with the communications network 65. The communications network 65 may be any collection of computers or communication devices interconnected by communication channels. The communication channels may be wired or wireless. Examples of such communication networks include, without limitation, local area networks, the Internet, and cellular networks. The connection to the communications network 65 allows the vehicle-mount computer 20 to communicate with other network nodes. For example, a central dispatcher could send instructions (e.g., a delivery schedule) from a scheduling server to the vehicle operator via the communications network 65.

An imaging device 90 is operably connected to the vehicle-mount computer 20. The imaging device 90 is capable of capturing images (e.g., moving images) and transmitting those images in electronic format (e.g., a digital video signal) to the vehicle-mount computer 20. Typically, the imaging device 90 is a video camera. More typically, the imaging device 90 is a universal serial bus (USB) video camera (e.g., a webcam). USB video cameras advantageously provide a suitable picture quality and frame rate at an affordable price compared to traditional, large-format video cameras. Furthermore, USB video cameras can be readily connected to various types of vehicle-mount computers 20, many of which now feature at least one USB port for connecting devices, such as the USB camera, transmitting data on the universal serial bus standard. In addition, USB video cameras are typically lightweight, making installation (e.g., mounting) of the USB camera onto the vehicle 100 relatively simple (e.g., by using a light-weight mounting bracket). The imaging device 90 may be tethered to the vehicle-mount computer via a USB cable, or it may be integrated into the vehicle-mount computer. The imaging device 90 may be capable of capturing sound, which sound may be recorded with the video images. Alternatively, a separate sound capturing device (e.g., a microphone) may be operably connected to the vehicle-mount computer 20 to capture sound associated with a vehicle event. This may be useful, for example, to capture any utterances of the vehicle operator during a vehicle event.

In an alternative embodiment, the imaging device 90 is integral with a barcode scanner 80. Adapting the barcode scanner 80 to incorporate imaging device 90 capabilities allows for fewer peripheral devices from the vehicle-mount computer 20. The barcode scanner 80 is removably mounted to the vehicle 100 in an orientation that allows for the capture of video data from the desired location proximate to or inside the vehicle 100. For example, the barcode scanner 80 having an integrated imaging device 90 could, when placed in a holster at the front of the vehicle cabin, obtain images proximate to the rear of the vehicle 100. In this orientation, the imaging device 90 could provide the vehicle operator with a live video feed of the area proximate the rear of the vehicle 100, which could assist when operating the vehicle 100 in reverse (e.g., a back-up camera).

Digital video typically represents very large amounts of data requiring extremely large memory capacity for long-term storage. With vehicle-mount computers 20 in particular, there is not nearly enough memory storage space to permanently store all video data captured by the imaging device 90. It is necessary to distinguish between data that is relevant to a vehicle event and data that is not relevant. Data that is not relevant is discarded; data that is relevant is preserved. This culling of data is achieved by a video manager 55. Typically, the video manager 55 is an application residing on the mass storage device 40.

The video manager 55 is configured to identify and preserve data (e.g., vehicle event data) that is relevant to a vehicle event. Vehicle event data includes video images depicting the vehicle event as well as other relevant data such as vehicle speed, vehicle position, and forklift position. A vehicle event is any occurrence that the vehicle owner or operator desires to be a triggering mechanism for the preservation of vehicle event data connected with such occurrence. For example, a vehicle event may be the occurrence of a sudden acceleration or deceleration of the vehicle 100, which sudden acceleration or deceleration may be indicative of an accident involving the vehicle 100. A vehicle event may also include the occurrence of a rollover of the vehicle 100. A vehicle event may also include the non-movement of the vehicle for a specified period of time (e.g., ten minutes), which non-movement may indicate a period of unacceptable non-productivity by the vehicle operator. The video manager 55 is informed of the occurrence of a vehicle event by readings received from an event sensor 95 that is operably connected to the vehicle-mount computer 20. An event sensor 95 may include an accelerometer, a gyroscope, an impact sensor, a global positioning satellite (GPS) receiver, a user-activated switch, and/or any other device capable of detecting a vehicle event. By way of example, an accelerometer may be used to detect sudden vehicle acceleration or deceleration; a gyroscope may be used to detect vehicle rollover; and a GPS receiver may be used to detect extended periods of inactivity (e.g., non-movement). Although FIG. 1 depicts the event sensor 95 as being a peripheral device to the vehicle-mount computer 20, the precise configuration of the event sensor 95 depends upon the application. Typically, an event sensor 95 such as an accelerometer or GPS receiver would be integrated into the vehicle-mount computer 20 (as opposed to being an external, peripheral device). The representation in FIG. 1 is intended to clarify the interaction between the vehicle-mount computer 20 and the event sensor 95, and is not intended to suggest a limitation on the location of the event sensor 95. The event sensor 95 may thus be integral with the vehicle-mount computer 20, or the event sensor 95 may be external to the vehicle-mount computer 20.

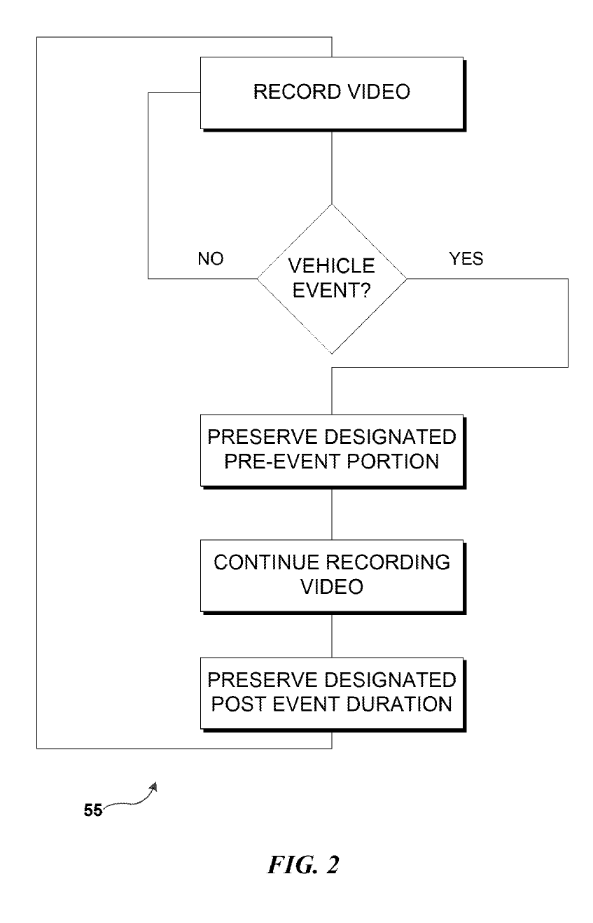

FIG. 2 is a flow chart depicting the logical operation of an exemplary video manager 55 of an exemplary system 10 according to the present invention. The video manager 55 is configured to at least temporarily store on the mass storage device 40 a specified duration of video captured by the imaging device 90, possibly in addition to other types of vehicle event data. For example, the video manager 55 may be configured to write to the mass storage device 40 fifteen minutes worth of video footage captured from an imaging device 90 positioned to capture images of the area in front of the vehicle 100. If the video manager 55 does not receive an indication from an event sensor 95 that a vehicle event has occurred, then the captured images are overwritten as new images are obtained. This approach prevents the mass storage device 40 from becoming quickly filled with data. Once an event sensor 95 detects a vehicle event, the video manager 55 preserves a designated duration of video captured immediately before the vehicle event. For example, the video manager 55 may be configured to preserve the video captured in the five minutes preceding the vehicle event. In addition, the video manager 55 may be configured to preserve a designated duration of video (e.g., five minute duration) immediately following a vehicle event. By preserving the video images (and potentially other vehicle event data) immediately preceding and immediately following the vehicle event, the system 10 affords investigators or other interested parties access to only the most relevant data, while not making unreasonable demands on system storage resources. The video manager 55 preserves the vehicle event data by storing it on the mass storage device 40 and/or transmitting it via the communications network 65 to a central hub (e.g., a dispatcher) along with instructions that the vehicle event data is not to be overwritten. Transmission of vehicle event data, including video footage of a vehicle event, over the communications network 65 to a central hub can facilitate virtually instantaneous assessment of the incident involving the vehicle. For example, if a dispatcher receives video footage showing a collision with a pedestrian, the dispatcher would immediately know to contact emergency personnel without waiting on the vehicle operator to report the incident.

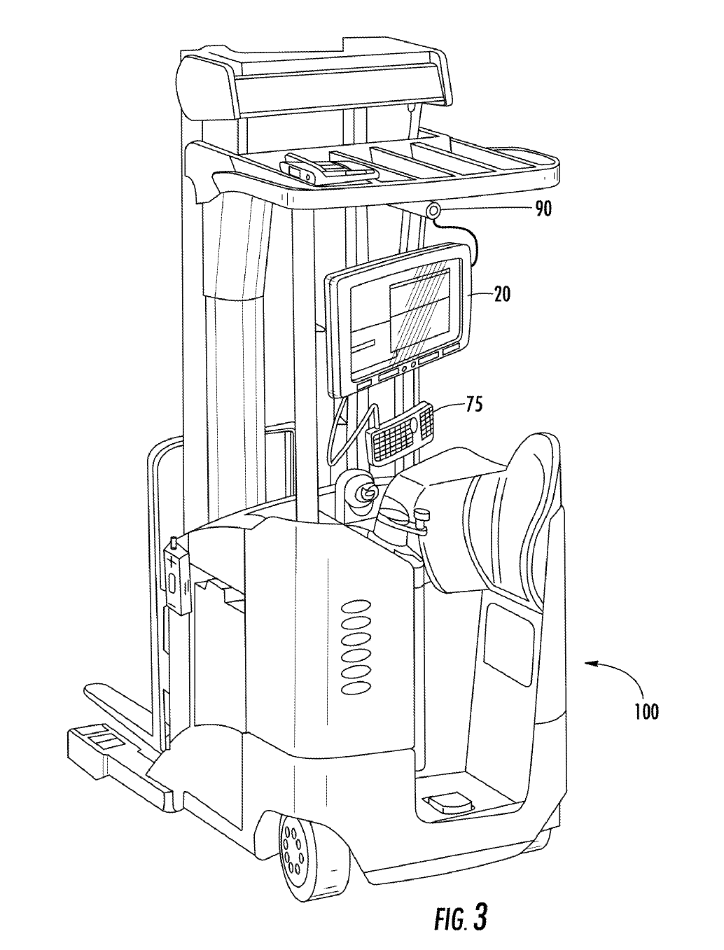

In another aspect, the invention embraces a vehicle adapted to capture and preserve vehicle event data. FIG. 3 is a perspective view of an exemplary vehicle 100 adapted to capture and preserve vehicle event data according to the present invention. A vehicle-mount computer 20 is mounted to the interior (e.g., cabin) of the vehicle 100. An imaging device 90 is mounted to the front exterior of the vehicle 100 and is operably connected to the vehicle-mount computer 20 (e.g., by a USB cable). The imaging device 90 is oriented to capture images of the area in front of the vehicle 100. It will be understood that the system 10 could include multiple imaging devices 90 oriented to capture video from different areas of the vehicle's 100 exterior or interior. For example, one imaging device 90 could be positioned to capture video images of the vehicle operator.

In the specification and figures, typical embodiments of the invention have been disclosed. The present invention is not limited to such exemplary embodiments. Unless otherwise noted, specific terms have been used in a generic and descriptive sense and not for purposes of limitation.

1. A system for capturing and preserving vehicle event data comprising:
an imaging device for capturing images;
an event sensor for detecting a vehicle event;
a vehicle-mount computer comprising a central processing unit and memory;
wherein said central processing unit is configured for, in response to the detection of a vehicle event by the event sensor, storing on said memory a designated duration of images captured by said imaging device before the detected vehicle event and a designated duration of images captured by said imaging device after the detected vehicle event.

2. The system of claim 1, wherein said vehicle-mount computer comprises a network interface.

3. The system of claim 2, wherein said event sensor comprises an accelerometer.

4. The system of claim 2, wherein said event sensor comprises a gyroscope.

5. The system of claim 2, wherein said event sensor comprises an impact sensor.

6. The system of claim 2, wherein said event sensor comprises a user-activated switch.

7. The system of claim 2, wherein said imaging device comprises a video camera.

8. The system of claim 2, wherein said imaging device comprises a universal serial bus video camera.

9. The system of claim 2, wherein said imaging device comprises a barcode scanner adapted to capture video images.

10. A method of capturing and preserving vehicle event data comprising:
capturing images with an imaging device;
detecting a vehicle event;
after detecting a vehicle event, storing a designated duration of images captured by the imaging device before the detected vehicle event; and
after detecting a vehicle event, storing a designated duration of images captured by the imaging device after the detected vehicle event.

11. The method of claim 10, comprising:
transmitting the designated duration of images captured by the imaging device before the detected vehicle event via a communications network; and
transmitting the designated duration of images captured by the imaging device after the detected vehicle event via a communications network.

12. The method of claim 10, wherein the imaging device comprises a video camera.

13. The method of claim 10, wherein the imaging device comprises a barcode scanner.

14. The method of claim 10, wherein the step of detecting a vehicle event comprises detecting a vehicle event with an accelerometer.

15. The method of claim 10, wherein the step of detecting a vehicle event comprises detecting a vehicle event with a gyroscope.

16. A method of capturing and preserving vehicle event data comprising:
capturing images with an imaging device;
detecting a vehicle event;
after detecting a vehicle event, transmitting a designated duration of images captured by the imaging device before the detected vehicle event via a communications network; and
after detecting a vehicle event, transmitting a designated duration of images captured by the imaging device after the detected vehicle event via a communications network.

17. The method of claim 16, wherein the imaging device comprises a video camera.

18. The method of claim 16, wherein the imaging device comprises a barcode scanner.

19. The method of claim 16, wherein the step of detecting a vehicle event comprises detecting a vehicle event with an accelerometer.

20. The method of claim 16, wherein the step of detecting a vehicle event comprises detecting a vehicle event with a gyroscope.
